(19) United States
(12) Patent Application Publication
(10) Pub. No.: US 2002/0172803 A1
(43) Pub. Date: Nov. 21, 2002

(54) Molded article and process for preparing same

(76) Inventors: Arthur K. Delusky, Detroit, MI (US); Stephen P. McCarthy, Tyngsboro, MA (US); Thomas M. Ellison, Fort Mill, SC (US)

Correspondence Address: Robert H. Bachman, BACHMAN & LaPOINTE, P.C., Suite 1201, 900 Chapel Street, New Haven, CT, 06510-2802, US

(21) Appl. No.: 10/097,551

(22) Filed: Mar. 12, 2002

Related U.S. Application Data
(60) Provisional application No. 60/292,745, filed on May 21, 2001.

(51) Int. Cl. B32B 3/00; B29C 43/18

(52) U.S. Cl. 428/156; 264/266

(57) ABSTRACT

The molded article includes at least one compression molded plastic layer having an inner surface and an outer surface thereof, and at least one plastic projection, as a boss or rib, extending from and bonded to the inner surface of the compression molded plastic layer. An outer plastic film is desirably bonded to the compression molded plastic layer and desirably compression molded therewith.

### CROSS-REFERENCE TO RELATED APPLICATION

This application claims the benefit of U.S. Provisional Application Ser. No. 60/292,745, filed May 21, 2001.

### BACKGROUND OF THE INVENTION

In accordance with U.S. Pat. No. 5,401,457 for PROCESS FOR FORMING A COLOR COATED ARTICLE, By Emery I. Valyi, Patented Mar. 28, 1995, a process is provided for forming a color coated article. In accordance with the procedure of the '457 patent, a film is placed substantially flat over a mold cavity and deformed by a core half and by molten plastic entering through a sprue. However, the procedure of the '457 patent is difficult to control, particularly when molding parts with large surfaces and sharply varying curvatures. The difficulties increase when the plastic is pressure molded at high enough temperatures to reduce the film strength substantially, as is the case with conventional injection molding procedures.

In accordance with U.S. Pat. No. 6,132,669, Issued Oct. 17, 2000, by Emery I. Valyi et al., a color coated article is prepared by depositing molten plastic on a film and forming the film-molten plastic combination in a mold cavity. This procedure and the resultant article effectively and efficiently forms a color coated article. However, it would be particularly desirable to further improve the resultant article particularly for molded articles with bosses or ribs, especially complex bosses or ribs.

Accordingly, it is a principal objective of the present invention to provide an improved molded plastic article and method for obtaining same which is convenient and expeditious and results in a highly advantageous article.

It is a still further object of the present invention to provide an improved article and method as aforesaid which results in an advantageous molded plastic article with bosses and/or ribs without jeopardizing the ease and convenience of final article preparation.

Further objects and advantages of the present invention will appear hereinbelow.

### SUMMARY OF THE INVENTION

In accordance with the present invention, the foregoing objects and advantages are readily obtained.

The molded article of the present invention comprises: a compression molded plastic layer having an inner surface thereof; preferably an outer film layer over said plastic layer and forming a composite laminate therewith, said outer film layer having an inner surface adjacent and bonded to said plastic layer and an outer surface opposed to said inner surface; and at least one extruded plastic projection, as a boss and/or rib, extending from and bonded to the inner surface of the plastic layer, wherein the extruded boss and/or rib is molded onto the compression molded plastic layer by extruding plastic onto the inner surface of the plastic layer.

In accordance with the process of the present invention, the plastic layer is compression molded, preferably with an outer film layer bonded to the plastic layer. In this process, the mold core is fitted with slides or the like that open to reveal cavities for the projections, as bosses and/or ribs to be molded on the inner surface of the compression molded article. After the plastic layer is made by compression molding and preferably during the cooling cycle thereof, mold core cavities adjacent the inner surface of the compression molded article are filled with molten plastic by a hot runner manifold extending to the mold core. The manifold is desirably fed from a second extruder, preferably separate from the first extruder used to form the plastic layer. Back pressure from the second extruder provides pressure to reduce or eliminate sink marks on the part show surface. Sink marks may be further reduced by allowing the resin from the first extruder to cool slightly before the bosses and/or ribs are extruded. The bosses and/or ribs are then extruded from the second extruder and bonded to the molded article.

Further features of the present invention will appear from the following disclosure.

### BRIEF DESCRIPTION OF THE DRAWINGS

The present invention will be more readily understandable from the following illustrative drawings, wherein:

FIGS. 1-3 are partly schematic views showing the apparatus and process for the preparation of the molded article of the present invention;

FIG. 4 is a schematic view showing the preparation of the article of the present invention; and

FIGS. 5-7 show sectional views of articles of the present invention.

### DETAILED DESCRIPTION OF PREFERRED EMBODIMENTS

Referring to FIGS. 1-3, a mold 10 consisting of cavity half 12 having a mold cavity 12a therein and core half 14 is mounted on respective platens 16 and 18. Mold cavity 12a has a shape of the desired final molded article. At least one of cavity half and core half is reciprocable in the direction of the arrow 20 from an open to a closed position and from a closed to open position via motive means (not shown). An extruder/injection unit 22 having a nozzle 24 is arranged adjacent mold 10 to coact and couple with a hot plastic delivery means, as plate 26. Plate 26 is relatively reciprocable in the direction of the horizontal arrow 28 from a position adjacent mold cavity 12a to a position spaced from mold cavity 12a and is supplied with hot, flowable plastic by extruder 22 and nozzle 24. Depending on the nature of plate 26, the extruder may be stationary or reciprocable with plate 26. Naturally, other variations in the hot plastic delivery system may be used. For example, the extruder/injection system and hot plastic delivery means may be stationary externally to the press and the mold traversed reciprocably relative to the extruder/injection system. Other variations may be readily contemplated.

Plate 26 in FIG. 1 is a hot runner having an elongated channel 30 which communicates with a multiplicity of openings 32 positioned over mold cavity 12a. Each opening is closeable by known means, as by valve means 34. The openings 32 receive hot plastic under pressure from extruder 22 through extruder nozzle 24 and hot runner feed channel 30. While the extruder 22 and hot runner delivery plate 26 are coupled, plastic is caused to flow from nozzle 24 into channel 30. For the delivery plate to operate when the extruder is detached, a free end 36 of channel 30 contains a check valve 38 (shown schematically), and pressurized piston means 40 are added to engage the opposed end 42 of channel 30 to operate by conventional means, for example, a hydraulic cylinder (not shown) to apply force to hot runner channel 30 in the direction of the horizontal arrow 44.

Alternatively, one could selectively close valve means 34 and apply pressure through piston means 40, thereby obtaining a thicker coating in desired locations. Alternatively, one could use shooting pots or plastic reservoirs, for example, connected to each individual valve means, thereby obtaining additional resin thickness where desired.

In one method of operation, the extruder 22 is left in place spaced from mold 10 and the plate 26 alone is moved into position over mold cavity 12a as shown in FIG. 1, after having been charged with hot plastic by extruder 22. To prevent drooling, check valve 38 is closed. In addition, piston means 40 may be retracted in engagement with channel end 42, thereby creating suction in channel end 42 to better retain the hot plastic therein.

A hold down and spacer frame 46 is aligned with cavity half 12, engageable therewith and detachable therefrom and coupled with means to move same (not shown) towards and away from cavity half 12 independently of the reciprocal movement of core half 14. Thus, a pair of lift cylinders 48 may be mounted on either platens 16 or 18 with mounting on platen 16 being shown in FIG. 1.

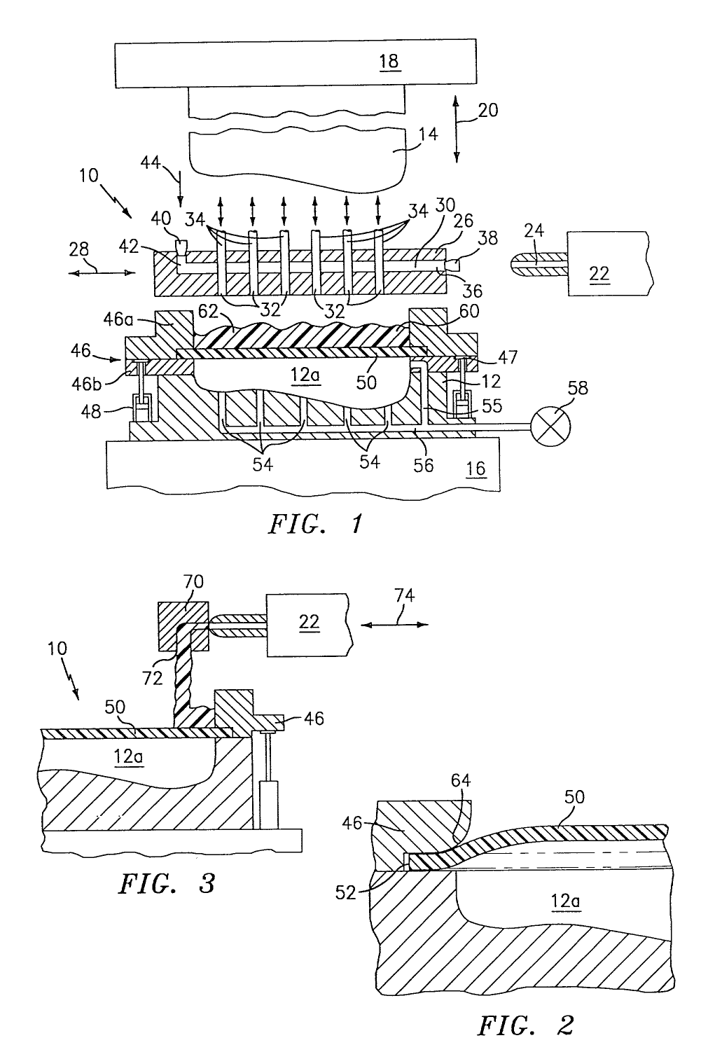

Thus, plate 26 is filled with hot plastic by extruder 22. If the two are coupled, they are moved so as to place the hot runner into alignment with cavity half 12. Before so placing the hot runner, spacer frame 46 is lifted away from cavity half 12 far enough to permit a precut film or blank 50 to be placed over the rim 52 (see FIG. 2) of the mold cavity 12a of cavity half 12 by any desired means, as for example, shown in the '457 patent. With the blank 50 in place, frame 46 is moved towards cavity half 12 to clamp blank 50 over the mold cavity 12a as shown in FIG. 2, thereby rendering said cavity capable of retaining elevated fluid pressure. Optionally, the film may be offset from the cavity and supported by air jets. Alternatively, spacer frame 46 may include an upper half 46a and a lower half 46b with a space 47 therebetween as shown in FIG. 1. This clamp may be a slip clamp to permit release of the film into mold cavity 12a during forming and thereby minimize edge scrap and reduce the amount of film thinning that may occur. If desired, scrap trim may be minimized by folding over excess film and heat sealing the excess film to inside edge portions of the molded article, as by ironing.

Fluid pressure may then be applied to mold cavity 12a under blank 50, as through channels 54 connected through a joint manifold 56 with pressure control means 58. The fluid usually used is air, but may also be an inert gas if the material of blank 50 so requires. Alternatively, fluid pressure may be applied through channel 55 in cavity half 12 directly beneath film blank or film 50 in order to properly hold the film in place. Preferably, a plurality of locations, or a continuous channel, are provided around the circumference of the film directly beneath the film. Also, these may be valved separately from channels 54 or used instead of channels 54.

Nozzle valve means 34 are then withdrawn to allow hot plastic to flow freely from hot runner plate 26 through nozzle openings 32 onto blank 50 in the space between the hot runner plate 26 and blank 50 and within frame 46. The space within frame 46 is not filled under substantial pressure, such as usual in injection molding. Rather, only an accurately metered amount 60 of hot plastic is deposited upon blank 50 from hot runner plate 26, namely that which corresponds substantially to the molding cavity to be formed in mold cavity 12a by cavity half 10 and core half 14 in the closed condition.

It is important to note that in consequence of introducing the hot plastic into the space within frame 46, no more pressure is applied underneath the blank via fluid channels 54 and 55 than that sufficient to support the metered amount 60 of plastic being so deposited. Desirably, the air pressure is variable depending on product requirements. Indeed, vacuum may be used during forming. As schematically indicated in FIG. 1, that metered amount 60 will comprise a plastic layer that will conform to the flat surface of the blank on one side, while its opposite surface will have an uneven surface 62 as clearly shown in FIG. 1, showing traces of the viscous flow pattern that will have emerged from nozzles 32. Naturally, the nozzles are spaced closely enough to permit the emerging plastic to form a continuous, homogeneous layer. Alternatively, one polymer could be deposited in a designed pattern, and a second or a plurality of second polymers deposited in a designed pattern. This could be done with one or more extruders feeding for example separate channels to deposit a predesigned pattern of multiple resins. As a further alternative, one could sequentially feed polymers of different characteristics to provide designed properties in the finished product.

Each of nozzles 32 may be independently temperature controlled, if desired, and hence capable of depositing the plastic in a pattern of predetermined temperature distribution.

Before releasing the hot plastic into the space above blank 50, the mold cavity 12a is optionally pressurized as described above, as by air pressure entering through channels 54. Since the finished product is usually thin, while having a large surface area, the weight of metered plastic 60 is relatively low and the average static pressure it exerts upon the film or blank 50 is low as well. Hence, relatively low pressure in the mold cavity will suffice to keep the blank 50 from sagging under the weight of the metered plastic, even when blank 50 is heated by contact with the metered plastic. For example, a metered amount of plastic measuring 2′×4′×0.5″, made of plastic weighing 0.05 pounds per cubic inch, will exert a pressure of 0.025 psi over the said area. This amounts to very slight over pressure to support the blank, with the result that said blank will not bulge (balloon) upward excessively when pressure is first applied under it. In exceptional instances, the layer of hot plastic being applied over the blank may be of much greater depth. Even then, the above indicated pressure would not cause excessive bulging. Forming of a crease-like line at the edge of spacer frame 46, may be prevented as shown by a curved clamping surface 64 thereof in FIG. 2 with slight upward bulging of film 50 shown caused by pressurization of mold cavity 12a. Indeed, upward bulging may be desirable in some instances, as for deep draw parts.

After deposition of the plastic layer 60 on film 50, plate 26 is moved from between cavity half 12 and core half 14 and mold 10 is closed, as by moving core half 14 into mold cavity 12a. This results in forming the film and deposited plastic into a composite laminate in the shape of the closed mold cavity in an expeditious and convenient manner.

The blank is preferably plastic that will conform and mold under the conditions of heat and pressure described in the molding process. Suitable plastic materials for the blank include but are not limited to polyolefins, polyvinyl chloride, polystyrene, acryonitrile-butadiene-styrene (ABS), polycarbonates and polyesters. Thermoplastic molding resins are selected for the molten resin such that the resin will bond to the blank when the molten resin is deposited. The same polymers listed for the blank are also suitable for the molten resin. These same polymers are also suitable for the subsequent injection of the bosses and/or ribs. The blank may be cut or stamped from a web and a supply of blanks having the size and shape to fit over mold cavity 12a maintained adjacent mold 10 for transfer to the mold as described above. The depth of color on the blank may naturally be varied depending on needs. One should naturally consider the thinning of the blank or film during processing and adjust the color depth to the amount of deformation any given portion of the blank or film is to undergo. Thus, for example, thicker paint coatings may be applied to selective blank or film locations that are to obtain greater deformation during processing in order to obtain uniformity of color in the final molded product. The blank or film may, for example, be intaglio-printed. The blank may be applied to the mold with robot means or removably adhered to a carrier film strip. A carrier film strip may be used to position the blank. Thus, for example, the carrier film strip may be provided with means to register the position of the blanks relative to the mold half onto which the blanks are to be placed, e.g., edge perforations. The carrier, with the blanks attached, may then be supplied from a roll. Once the blank and mold are juxtaposed, suction is applied to the edge of the blank by the mold, as through channels, sufficient to separate the blank from the carrier strip. Naturally, other transfer means may readily be used.

FIG. 3 shows an alternate method for applying the hot plastic. Instead of plate 26 being a hot runner as shown in FIG. 1, the extruder 22 is coupled with a so-called coat hanger die 70, serving as a hot plastic delivery plate, i.e., die with a slit opening 72 for the plastic as normally used for the extrusion of wide sheets. The extruder 22 and die 70 are reciprocable in the direction of arrow 74 towards and away from mold 10. In operation, the blank 50 having been placed over the mold cavity 12a and clamped down as by spacer frame 46, as in FIGS. 1-2, the extruder 22 and die 70 are traversed over blank 50, and the desired layer of hot plastic is deposited thereover. The thickness of the plastic layer is given by the speed of traverse, the output of the extruder and the dimensions of the die, all controlled in a conventional manner. At the end of the traverse, the extruder is shut off and returned to its starting position. One may provide an extruder with width and/or thickness control to control the thickness and/or width of the plastic layer. The speed of traverse and/or the output of the extruder could be variable. The positioning of the extruder in the X, Y and Z planes could be variable to vary the dimensions and/or configuration of the plastic layer.

A significant feature of the present invention is the uniformity of heating of the film or blank without having to resort to external means, and the assurance that the forming operation is carried out simultaneously, film or blank and the backing layer, followed by the application of high enough molding pressures to provide mold conformance of both. The finish of the film is thereby preserved and optically detectable imperfections are minimized. Also, this procedure requires much lower clamping pressure than conventional procedures.

While the foregoing procedure is aimed primarily at application in the exterior of vehicles, it should be noted that there are many other types of components that would benefit from the subject process of compression molding with a colored finish and with an accurately molded article, particularly for large household appliances and architectural components.

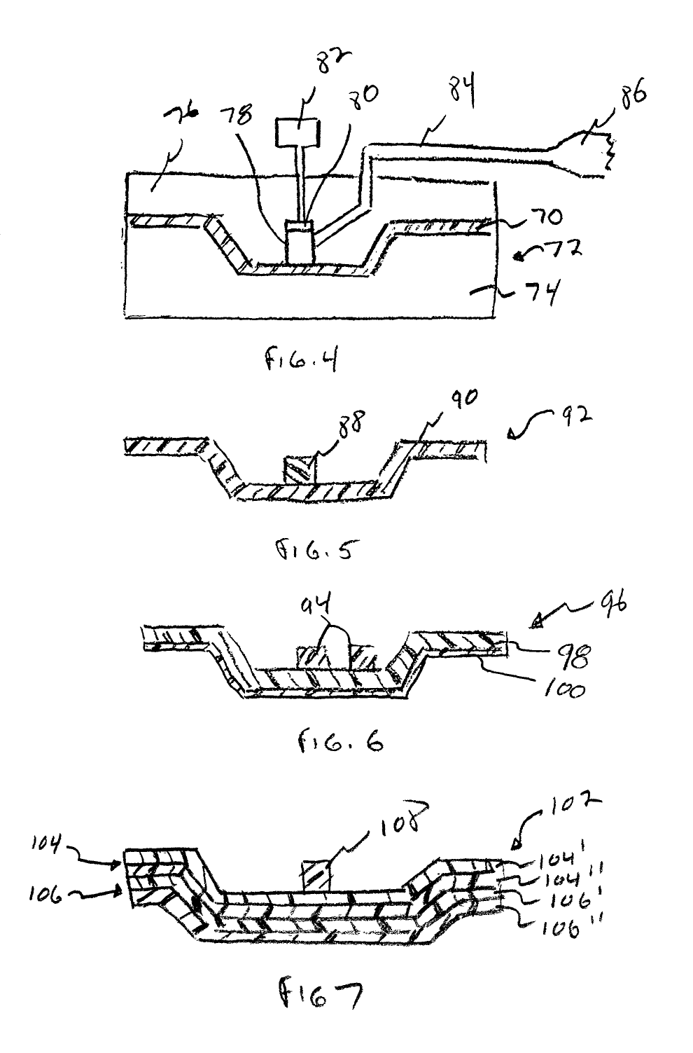

Referring to FIGS. 4-6, in accordance with the present invention, a compression molded part is first formed with plastic layer 70 in mold 72 between cavity half 74 and core half 76 by compression molding in a manner after FIGS. 1-3. The bosses and/or ribs are subsequently formed as will be discussed below. If desired, the outer film can be present as shown in FIG. 1, or the plastic layer 70 can be preformed in sheet form and compression molded as shown in FIG. 4. After the plastic layer 70 is compression molded, the bosses and/or ribs are formed on the compression molded plastic layer to form the article of the present invention. Mold core 76 includes one or more cavities 78 which are blocked from the compression molded plastic layer 70 during the compression molding cycle by any suitable blocking means, as movable blocking member 80 movable by motive means 82 from a first position adjacent the compression molded plastic layer to a second position spaced from the plastic layer. FIG. 4 shows the blocking member 80 in the second spaced position. After formation of compression molded layer 70, blocking member 80 is moved to the second position, cavity 78 is filled with molten plastic by hot runner manifold 84 desirably fed from a second extruder 86 to form the desired boss and/or rib 88 on the inner surface 90 of compression molded plastic layer 70. The boss and/or rib 88 bonds to the inner surface 90 of plastic layer 70 by melt bonding, but a bonding aid can be used if desired.

The resultant molded article 92 is shown in FIG. 5 and can have a single boss or rib 88 or multiple bosses or ribs, such as the two bosses or ribs 94 shown on molded article 96 in FIG. 6, based on particular requirements. Molded article 96 in FIG. 6 includes inner compression molded plastic layer 98 and outer compression molded film layer 100, as shown in FIG. 1.

Variations on the present invention may include for example multiple plastic layers, reinforcements, and as indicated above multiple bosses and/or ribs. Further the molded article of the present invention is simply and easily prepared and serves a significant commercial need. Thus, for example, as shown in FIG. 7, article 102 includes inner compression molded layer 104 having first plastic layer 104′ and second innermost plastic layer 104′ and second plastic layer 104″, and compression molded plastic film layer 106 having first innermost plastic layer 106′ adjacent to and bonded to layer 104″ and second film layer 106″ which is the outermost layer. One or more bosses or ribs 108 are bonded to the inner surface of plastic layer 104′.

It is to be understood that the invention is not limited to the illustrations described and shown herein, which are deemed to be merely illustrative of the best modes of carrying out the invention, and which are susceptible of modification of form, size, arrangement of parts and details of operation. The invention rather is intended to encompass all such modifications which are within its spirit and scope as defined by the claims.

What is claimed is:

1. Molded article, which comprises: at least one compression molded plastic layer having an inner surface and an outer surface thereof; and at least one extruded plastic projection bonded to and extending from the inner surface of the compression molded plastic layer.

2. Molded article according to claim 1, wherein said plastic projection is one of a plastic boss and rib.

3. Molded article according to claim 2, including at least one outer film layer over the outer surface of said plastic layer and forming a compression molded composite laminate therewith, said outer film layer having an inner surface adjacent to and bonded to the outer surface of said plastic layer and an outer surface opposed to said inner surface.

4. Molded article according to claim 3, wherein said outer film layer is a plastic film and wherein said plastic layer and outer plastic film layer are compression molded.

5. Molded article according to claim 4, wherein said outer plastic film layer is colored.

6. Molded article according to claim 4, wherein said outer plastic film layer is selected from the group consisting of polyolefins, polyvinyl chloride, polystyrene, acryonitrille-butadiene-styrene, polycarbonates and polyesters.

7. Molded article according to claim 6, wherein the plastic layer is a thermoplastic layer bonded to the outer plastic film.

8. Molded article according to claim 4, including multiple projections.

9. Molded article according to claim 4, including multiple plastic layers.

10. Molded article according to claim 4, including multiple outer film layers.

11. Process, which comprises: compression molding at least one plastic layer to provide a plastic layer with an inner surface and an outer surface thereof, extruding at least one plastic projection; and bonding said plastic projection to the inner surface of the compression molding plastic layer so that said plastic projection extends from the inner surface of said compression molded plastic layer.

12. Process according to claim 11, including the step of extruding at least one projection which is one of a plastic boss and plastic rib.

13. Process according to claim 12, including the step of providing at least one outer film layer over the outer surface of said plastic layer and compression molding said outer film layer and plastic layer to form a compression molded composite laminate, wherein said outer film layer has an inner surface adjacent to and bonded to the outer surface of said plastic layer and an outer surface opposed to said inner surface.

14. Process according to claim 13, including the step of providing that said outer film layer is plastic, and including the step of compression molding said outer film layer and plastic layer together.

15. Process according to claim 14, including: compression molding said plastic layer and outer film layer with a mold core having at least one closed cavity therein facing the inner surface of said plastic layer; filling said cavity with plastic material for said projection; opening said cavity after compression molding; and molding said projection after compression molding said plastic layer and outer film layer to bond said projection to the inner surface of said plastic layer.

16. Process according to claim 14, including the step of providing separate extruders for said plastic layer and projections; and extruding plastic from said separate extruders to separately form said plastic layer and projections.

17. Process according to claim 14, including the step of forming multiple projections.

18. Process according to claim 14, including the step of providing multiple plastic layers.

19. Process according to claim 14, including the step of providing multiple outer film layers.
